(19) United States
(12) Patent Application Publication
(10) Pub. No.: US 2015/0193151 A1
(43) Pub. Date: Jul. 9, 2015

(54) UNIVERSAL PORTABLE STORAGE DEVICE

(71) Applicant: Imation Corp., Oakdale, MN (US)

(72) Inventors: Toshihide Hokari, Woodbury, MN (US); Alan Olson, Cottage Grove, MN (US); Blake A. Verdon, St. Paul, MN (US)

(21) Appl. No.: 14/589,167

(22) Filed: Jan. 5, 2015

Related U.S. Application Data
(60) Provisional application No. 61/923,892, filed on Jan. 6, 2014.

(51) Int. Cl. G06F 3/06; G06F 13/28

(52) U.S. Cl. CPC G06F 3/0607; G06F 3/0679; G06F 3/0655; G06F 13/28

(57) ABSTRACT

Aspects of the invention generally relate to a portable storage device having a memory and a standard connector for connecting to a variety of other devices, such as smartphones, tablets, computers, or others. For example, the standard connector can be configured to interface with a cable having a corresponding standard connector on one end and a device-specific connector on the other such that the cable provides the connection between the portable storage device and the other device. The portable storage device can interface with one of such other devices via the standard connector to receive digital data from the other device for storage in memory, or can allow access to digital data stored in memory by the other device.

### RELATED APPLICATIONS

The present application claims priority to U.S. provisional application No. 61/923,892, the entire contents of which are incorporated herein by reference.

### BACKGROUND

Remote devices with multiple functionalities are becoming increasingly popular. For example, a smartphone will often serve not only as a user's cellular phone, but also as the user's photo and video camera and music and video player, in addition to an ever-increasing number of other functions. As the functionality of such devices grow, the demand on the memory storage capacity increases. When the memory of the remote device becomes full, a user must unload digital data from the memory so that he or she can continue to utilize the remote device as intended, for example by capturing images or videos. In addition, many remote devices have specific and varying connection ports for interfacing with the device. As such, a user must have the appropriate connector with them in addition to means for receiving digital data from the remote device.

The sharing of digital data between remote devices is also a popular feature. However, because devices are configured differently and require varying connectors for interfacing, sharing typically must be performed by first moving digital data off of one device onto, for example, a computer, and then uploading the digital data to the second device. This is inconvenient as often users do not readily have access to such a device when desiring to share data. The alternative is to use wireless data transfer, which can be slow and/or expensive for a user.

### SUMMARY

Aspects of the present invention provide a portable storage device having a memory. The portable storage device comprises a connector for connecting to a remote device. The connector can be a dedicated connector for a particular remote device. In some examples, the memory of portable storage is in two-way communication with the remote device via the connector, allowing for the transfer of digital data between the two devices. In some configurations, the connector can provide two-way data transfer between the memory of the portable storage device and the remote device. Thus, a user can connect the remote device to the portable storage device and unload digital data from the memory of the remote device.

The portable storage device can include a second connector for connecting to an external device such as a computer. The second connector can allow two-way data transfer between the memory of the portable storage device and the external device. This allows a user to unload digital data from the memory of the portable storage device, freeing the memory for further use.

In some cases, a remote device may be unable to interface with a connector on the portable storage device. However, in many cases, remote devices are sold with an associated cable having a first end for interfacing with the cable and a second end for interfacing with a common external device, such as a computer. Accordingly, the second end often comprises a standard connector such as a USB connector so that the user can interface the remote device with such an external device. As such, in some embodiments, the connector of the portable storage device for connecting to a remote device comprises a standard connector for connecting to a cable associated with the remote device, such as a female USB connector.

### BRIEF DESCRIPTION OF THE DRAWINGS

FIG. 1A is a schematic diagram of a universal portable storage device having a standard connector.

FIG. 1B illustrates an exemplary embodiment of a portable storage device comprising a single standard connector.

FIG. 2 is a process-flow diagram illustrating exemplary operation of a portable storage device.

FIG. 3A is a schematic diagram of a portable storage device including a rechargeable power source.

FIG. 3B illustrates an exemplary portable storage device comprising a single standard connector and a rechargeable power source.

### DETAILED DESCRIPTION

Exemplary embodiments of the invention comprise a portable storage device. In some embodiments, the portable storage device includes a memory and at least two connectors, and is configured to interface with a remote device. In general, a remote device is a device that stands alone from a traditional central or local computer and can be used to acquire and/or display or otherwise present digital data such as photographs, video and audio to a user. Such remote devices can include, for example, cellular telephones, smartphones, tablets, cameras, displays, music players and the like. Exemplary connectors to such remote devices can include USB, micro-USB, mini-USB, HDMI, MHL, Lightning, 30-pin, serial connectors and any other connectors known in the art. In various embodiments, connectors can be specific or proprietary to a remote device.

In some embodiments, portable storage device includes a connector for interfacing with a particular remote device. However, in some situations, or over time, the types of connectors that interface with particular remote devices update or change as new technology and/or proprietary devices and connections are created. Additionally, various remote devices interface with different types of connectors. As such, it can be difficult or impossible to create a portable storage device having a fixed connector that will function with alternate or future variations of various remote devices.

However, in many cases, such remote devices are sold or provided with an associated cable having a first end for connecting to the remote device and a second end having a standard or universal connector for connecting to a common device such as a computer. With this cable, the user is likely able to provide an interface between the remote device and, for example, his or her personal computer. Such a standard connector can comprise, for example, a USB connector. For example, many smartphones are provided with a cable having a first end for connecting to the smartphone and a second end comprising a male USB connector for interfacing with a computer.

Accordingly, in some embodiments, the portable storage device can be configured to interface with the cable provided with the remote device as opposed to the device itself In such embodiments, in place of a specific connector, the portable storage device can include a standard connector for connecting with the universal connector of the cable associated with the remote device. With such a configuration, a portable storage device can interface with several different remote devices and be more likely to interface with updated versions of remote devices via its standard connector.

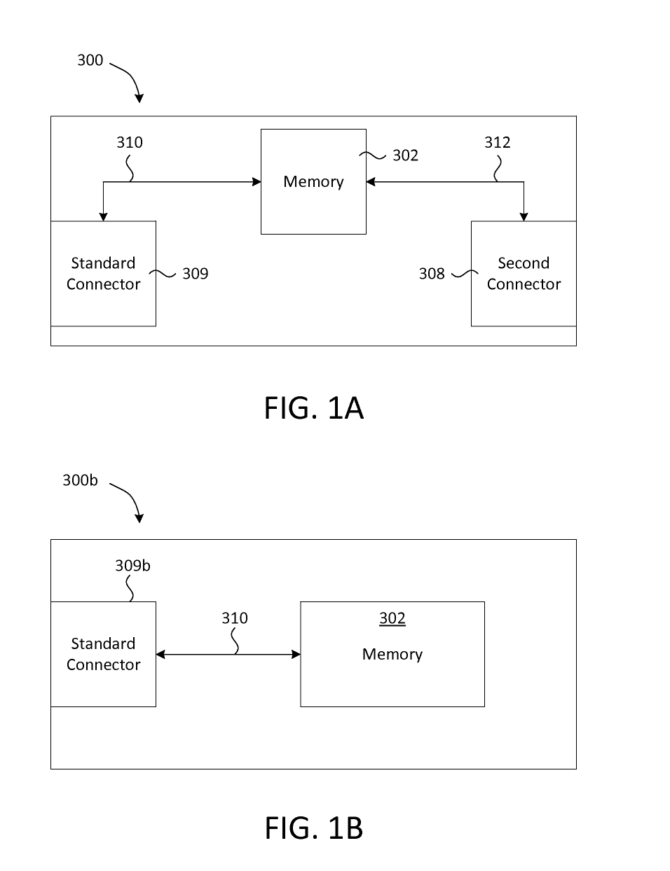

FIG. 1A is a schematic diagram of an exemplary portable storage device including a standard connector according to some embodiments of the invention. In some embodiments, the portable storage device 300 includes a memory 302, a standard connector 309, and a second connector 308. Standard connector 309 can be, for example, a female USB connector. In some embodiments, standard 309 and second 308 connectors can be integrated into a housing of the portable storage device 300. In alternative embodiments, one or both of the standard 309 and second 308 connectors can be attached to the housing by cable configured to provide communication between the connectors internal components of the portable storage device 300. In some embodiments, such a cable can be integrally coupled to the portable storage device 300, or can alternatively be removable therefrom. In various embodiments, standard 309 and second 308 connectors can be the same or different connectors.

Standard connector 309 can be communication with memory 302 via two-way communication 310. Two-way communication 310 can be used to send data from the remote device to memory 302 or to retrieve data from memory 302 to send to the remote device. Memory 302 can include flash technology, hard drive technology, or other storage technologies known in the art. In some embodiments, flash memory is used to minimize the physical size required for the portable storage device. Accordingly, some portable storage devices include flash memory 302 in sizes of, for example, 16, 32, 64, 128, 256 or 512 GB, or 1 TB. In some embodiments, portable storage device comprises dedicated, built-in memory 302. Device 300 can alternatively or additionally receive or comprise removable memory 302, such as an SD or microSD card. Removable memory 302 can allow the user to provide an appropriate amount of memory for the portable storage device in accordance with the user's desired capacity and cost. To facilitate removable memory 302, the portable storage device 300 can comprise a slot or receptacle for receiving removable memory 302. A user can insert or remove memory 302 into or from receptacle. Thus, in some embodiments, the memory 302 of the portable storage device 300 is of a variable size, wherein the user can insert memory 302 of any desirable size and can exchange one sized memory for another.

A remote device can be connected to the portable storage device 300 via the standard connector 309 and thereby interface with memory 302 via two-way communication 310 to facilitate the transfer of digital data between the portable storage device 300 and the remote device. In some examples, a user can choose to copy digital data from the remote device to the memory 302 of the portable storage device 300 to back up the data, or to move the data from the remote device to memory 302 to clear space on the remote device. Thus, as used herein, transferring data can refer to moving or copying data from one location to another. In addition, the user can choose to upload digital data from the memory 302 of the portable storage device to the remote device, or to stream digital data from memory 302 to the remote device. Thus, two-way communication 310 allows a user to move data back and forth between a remote device and the memory 302 of the portable storage device by means of the standard connector 309.

During an exemplary use, a user operates his or her remote device, such as a smartphone, for acquiring digital data. Data can comprise, for example, music, video, or image data captured by the user using the remote device. With use, the memory of the remote device becomes full. A user can connect the remote device to the portable storage device via a remote device cable and the standard connector 309 and move digital data from the internal memory of the remote device to the memory 302 of the portable storage device via connection 310 in order to clear space for acquiring more digital data. After data has been moved from a first remote device to the memory 302, a user can connect a second remote device to the standard connector 306 and transfer the digital data from memory 302 to the second remote device, utilizing the portable storage device 300 to facilitate the transfer of digital data between separate remote devices.

Thus, the user can use the portable storage device 300 to clear space on the remote device, thereby increasing its operating capacity (e.g., memory space). A user can also connect the remote device to the portable storage device in order to transfer data from the portable storage device to the remote device, or to stream data from the portable storage device. For example, a user can connect a smartphone to the portable storage device and play a video file on the smartphone that is located on memory 302 in portable storage device.

In some embodiments, when connected, the remote device and portable storage device adopt a ‘master/slave’ or a ‘host/device’ relationship. That is, the remote device (master, host) controls the operation of the portable storage device (slave, device). During operation, a user controls two-way data transfer between the remote device and the portable storage device via the remote device. In some configurations, such as in the case of some smartphones or tablets, for example, the user installs an application (app) or other software on the remote device that allows data transfer control operability. In other embodiments, such operability and/or software is available on the remote device by default. In either case, the user initiates the transfer of data in either direction between the two devices.

Through use, the memory 302 in the portable storage device becomes full. In some embodiments, the portable storage device comprises a second connector 308 for connecting to an external device. In some embodiments, the second connector 308 comprises a male USB connector, and the external device comprises a computer. The external device can connect to the second connector 308 and provide two-way communication via connection 312. Thus, the user can initiate two-way data transfer between the portable storage device and the external device, enabling the clearing of memory 302 to provide available storage in the portable storage device. In some embodiments, the interface between the portable storage device and the external device adopts a similar host/device relationship as described above, in which data transfer is controlled via the external device.

In some embodiments, the functionality of the second connector can be integrated into the standard connector, allowing for the standard connector to be connected to a remote device as well as an external device, via a cable, for example. FIG. 1B illustrates an exemplary embodiment of a portable storage device comprising a single standard connector. In FIG. 1B, the portable storage device 300b comprises a standard connector 309b for interfacing with a remote device as described above, allowing the transfer of digital data to or from a remote device from memory 302. In some uses, a user can transfer data to memory 302 from a first remote device via standard connector 309b, and transfer the data from memory 302 to a second remote device via the same standard connector 309b.

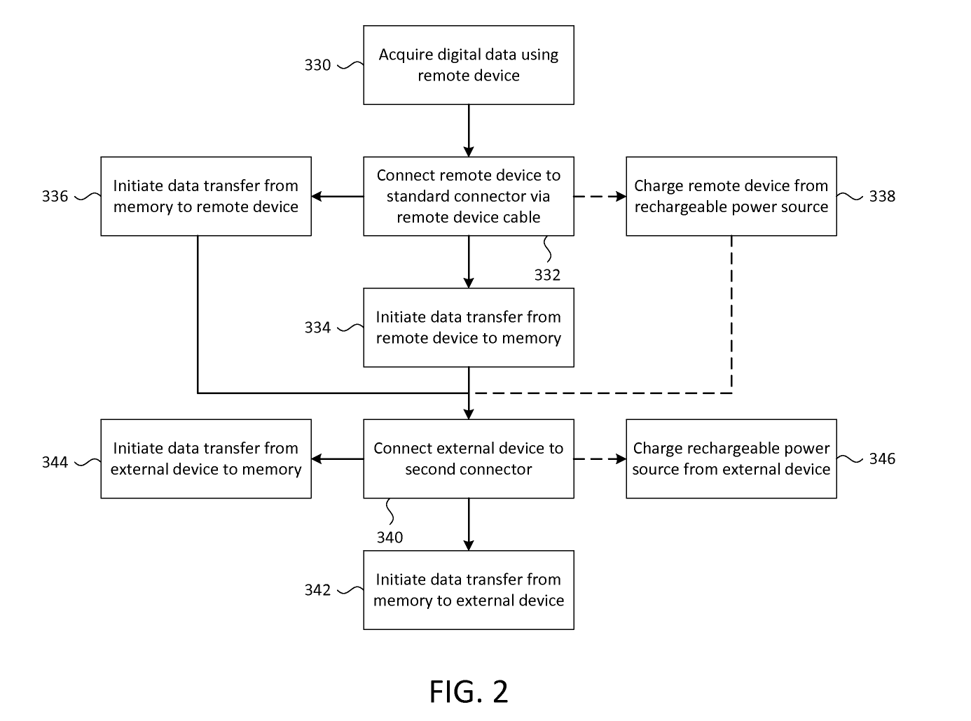

FIG. 2 is a process flow diagram illustrating exemplary operation of a portable storage device in conjunction with an external device and a remote device having a standard connector such as described above. Accordingly, the process outlined in FIG. 2 utilizes a remote device cable and a standard connector on the portable storage device. A user can begin by using a remote device, such as a smartphone. In some examples, the user can use the remote device to acquire 330 digital data, such as taking pictures or recording video data. Performing such operations drain the battery of the remote device as well as use space in the memory of the remote device. As the remote device memory becomes full and/or the battery becomes depleted, the user can connect 332 the remote device to the portable storage device via the remote device to the standard connector of the portable storage device via the remote device cable. Such a process can comprise connecting a first end of the remote device cable to the remote device and connecting the second end of the remote device cable to the standard connector on the portable storage device. In some embodiments, the first end of the remote device cable can include a connector specific and/or proprietary to the remote device, while the second end comprises a universal connector, such as a male USB connector. The standard connector of the portable storage device can include, for example, a female USB connector.

Two-way communication between the remote device and the portable storage device via the remote device cable and standard connector allows the user to initiate 334 data transfer from the remote device to the memory of the portable storage device, or to initiate 336 data transfer from the memory of the portable storage device to the remote device.

In addition, the user can connect 340 the portable storage device to an external device, such as a computer, via its second connector. In various embodiments, the user can do so while the portable storage device is connected to the remote device via the standard connector and remote device cable. Upon connection of the portable storage device with the external device, the user can initiate 342 data transfer from the memory of the portable storage device to the external device to move or copy digital data from the memory in the portable storage device. The user can also initiate 344 data transfer from the external device to the memory of the portable storage media. In general, processes outlined in FIG. 2 can be performed with various steps permuted, omitted, or performed simultaneously, depending on the preference or intention of the user and the embodiment of the portable storage device.

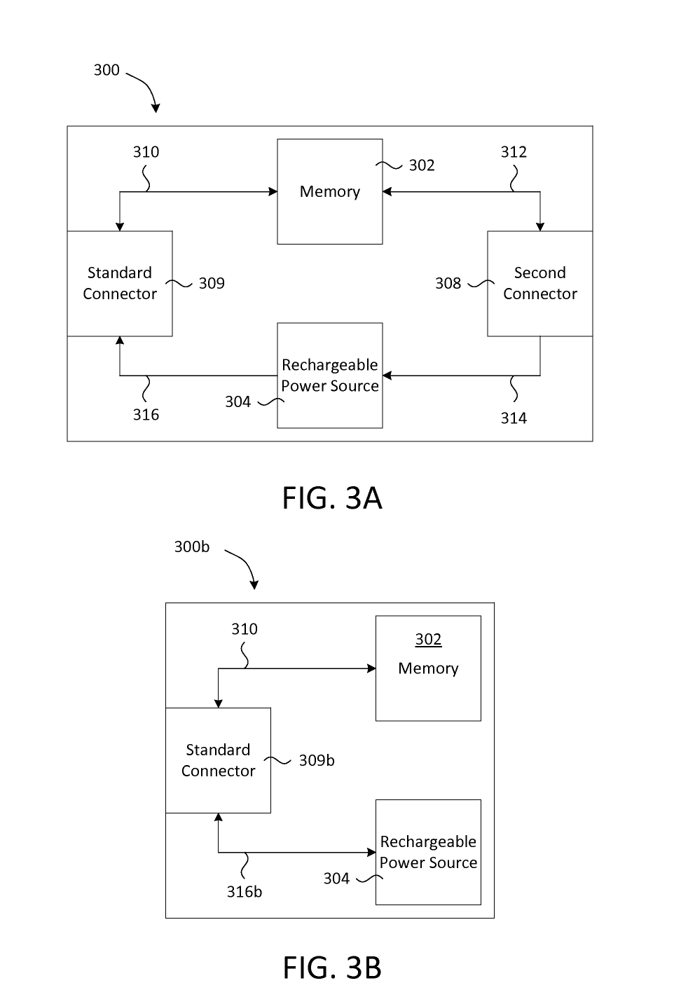

In some embodiments, portable storage device 300 can include a rechargeable power source 304 such as that shown in FIG. 3A. FIG. 3A is a schematic diagram of a portable storage device including a rechargeable power source. As shown, standard connector 309 can coupled to the rechargeable power source 304. Rechargeable power source 304 can include known rechargeable elements including lithium ion, lithium polymer, nickel metal hydride, capacitive or other known rechargeable power storage technology. During use, when a user connects a remote device to the standard connector 309 of the portable storage device 300, the rechargeable power source 304 of the portable storage device 300 can provide electrical power to the remote device via the standard connector 309. Rechargeable power source 304 can provide power to the remote device via a one-way connection 316. This power can be used to charge the battery of the remote device.

In various embodiments, the capacity of the rechargeable power source 304 can range between about 1000 and 5000 mAh. In some embodiments, the capacity of the rechargeable power source 304 is specific to a particular remote device, having the same or similar capacity as a particular remote device. In some embodiments, the user can control whether or not the remote device is charged by the portable storage device 300. In further embodiments when a remote device is connected to the standard connector 309, a user of the remote device can control whether the remote device is charged by the portable storage device 300. In other embodiments, charging of the remote device occurs automatically when connected via the standard connector 309.

In some configurations, when the second connector 308 is connected to an external device, the external device can provide electrical power to the rechargeable power source 304 via connection 314. Thus, when the rechargeable power source 304 becomes depleted of charge, it can be recharged via the external device and the second connector 308, and can subsequently be used to charge a remote device via standard connector 309, for example. In some embodiments, charge can be transferred to or from the rechargeable power source 304 while data is being transferred to or from memory 302. Accordingly, a user can simultaneously charge a remote device and transmit digital data to or from the remote device via the standard connector 309. Similarly, a user can simultaneously charge the rechargeable power source 304 and transfer digital data to or from an external device via the second connector 308.

Operability of the portable storage device including a rechargeable power source is illustrated in FIG. 2 and shown in broken lines. For example, as shown in FIG. 2, once a user connects 332 the remote device to the standard connector, the resulting connection can charge 338 the remote device from the rechargeable power source. In addition, once a user connects 340 an external device to the second connector, the resulting connection can charge 346 the rechargeable power source from the external device.

As described with regard to FIG. 1B, in some embodiments, the functionality of the second connector can be integrated into the standard connector. FIG. 3B illustrates an exemplary portable storage device comprising a single standard connector and a rechargeable power source. In the illustrated embodiment of FIG. 3B, the standard connector 309b is in two-way communication with the rechargeable power source 304 via connection 316b so that electrical power can be supplied to the rechargeable power source 304 via the standard connector. Accordingly, in such an embodiment, the standard connector 309b can be used to connect to an external device to transfer data back and forth between the external device and the memory 302 of the portable storage device 300b, as well as provide electrical power from the external device to the rechargeable power source 304.

In some further embodiments, the portable storage device 300 can include a connector for connecting to a power receptacle such as a plug for a wall socket for charging the rechargeable power source. Such a connector can be embedded into a sidewall of the portable storage device or can be attached thereto via a cable, for example. Such an embodiment provides an alternative connection via which a user can charge the rechargeable power source 304 within the portable storage device 300 if, for example, a standard power outlet is available and the user is without his or her charging cable.

Various examples have been described. Portable storage devices can include standard connectors for interfacing with, for example, a universal cable provided with a particular remote device. Embodiments of the portable storage device can include a second connector for connecting to an external device and optionally additional connectors, or may operate using only a single standard connector. Embodiments described herein are exemplary in nature and do not limit the scope of the invention.

1. A method comprising:
providing a remote device, a cable having a first end connectable to the remote device and a second end, and a portable storage device comprising:
memory;
a standard connector connectable to the second end of the cable; and
a second connector connectable to an external device and capable of providing two-way data transfer between the memory of the portable storage device and an external device;
connecting the first end of the cable to the remote device;
connecting the second end of the cable to the standard connector of the portable storage device;
transferring digital data (i) from the remote device to the memory of the portable storage device or (ii) from the memory of the portable storage device to the remote device via the cable.

2. The method of claim 1, wherein the memory comprises flash memory.

3. The method of claim 1, wherein the second connector comprises a male USB connector.

4. The method of claim 1, wherein the second end of the cable comprises a male USB connector and the standard connector comprises a female USB connector.

5. The method of claim 1, wherein the memory comprises removable memory.

6. The method of claim 1, wherein the remote device is a smartphone or a tablet.

7. The method of claim 1, wherein transferring data from the memory of the portable storage device to the remote device comprises streaming data from the memory of the portable storage device for display on the remote device.

8. The method of claim 1, wherein transferring digital data is controlled via the remote device.

9. The method of claim 1, wherein the portable storage device includes a rechargeable power source, and further comprising:
providing electrical power from the rechargeable power source of the portable storage device to the remote device.

10. The method of claim 9, further comprising:
connecting the second connector to an external device;
providing electrical power from the external device to the rechargeable power source of the portable storage device; and
transferring digital data (i) from the memory of the portable storage device to the external device or (ii) from the external device to the memory of the portable storage device.

11. A portable storage device comprising:
memory;
a standard connector connectable to a universal connector and capable of providing two-way data transfer between the memory of the portable storage device and a remote device; and
a second connector connectable to an external device and capable of providing two-way data transfer between the memory of the portable storage device and an external device.

12. The portable storage device of claim 11, wherein the standard connector comprises a female USB connector.

13. The portable storage device of claim 11, further comprising a rechargeable power supply;
and wherein the standard connector is capable of providing electrical power from the rechargeable power source of the portable storage device to the remote device while simultaneously providing two way communication between the memory of the portable storage device and the remote device; and the second connector is capable of providing electrical power from the external device to the rps of the portable storage device.

14. A portable storage device comprising:
memory; and
a standard connector connectable to a universal connector and capable of providing two-way data transfer between the memory of the portable storage device and a remote device.

15. The portable storage device of claim 14, further comprising a rechargeable power supply; and wherein the standard connector is capable of providing electrical power from the rechargeable power source of the portable storage device to the remote device while simultaneously providing two way communication between the memory of the portable storage device and the remote device.
